(19) United States
(12) Patent Application Publication
(10) Pub. No.: US 2010/0306686 A1
(43) Pub. Date: Dec. 2, 2010

(54) METHOD FOR REPRESENTING A USER, AND CORRESPONDING DEVICE AND COMPUTER SOFTWARE PRODUCT

(75) Inventors: Karima Rafes, Issy-Les-Moulineaux (FR); Christian Bourliataud, Plaisir (FR); Pascal Belin, Villennes Sur Seine (FR); Alban Martin, Paris (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/680,513

(22) PCT Filed: Sep. 25, 2008
(86) PCT No.: PCT/FR2008/051713

§ 371 Date: May 19, 2010

(30) Foreign Application Priority Data
Sep. 28, 2007 (FR) 0757966

(51) Int. Cl. G06F 3/048; G06F 15/16

(52) U.S. Cl. 715/765; 709/217

(57) ABSTRACT

The invention relates to a method of representing a user. According to the invention, the method includes a step of configuring at least one means for representing said user taking account of at least one representation parameter derived from at least one geographical location information item obtained from a terminal in the possession of said user.

The present invention relates to the field of telecommunications.

The present invention relates more particularly to managing digital clones that a user possesses either physically or via a representation in a communications network.

A digital clone includes data abstracted from parameterizable characteristics representative of a user. This abstract data takes the form of a configuration file, for example. The digital clone has an interface enabling the user to be represented in the world in which the clone functions. For example, on the Internet, the interface of a clone could be an avatar. It has already been suggested that, within a home, the interface of a clone could be a robot or any other form of communicating object.

At the present time, the expression and representation possibilities of digital clones are very limited because of the nature of the technologies used. This very recent concept of a “digital clone” corresponds to a virtual representation of the user which until now has been the subject of only spasmodic development, generally with the aim of imparting to the clone intelligence and a personality close to that of the user that it is deemed to represent. Numerous experiments and trials have been carried out in these lines, in particular by storing opinions or recollections of the user on a computer memory in order to make an interlocutor believe that they are communicating with the user rather than with a representation of the user.

Conversely, the technologies used to represent users are mostly basic and on the Internet generally represent them in the form of an avatar, that is to say an image or a basic animation that the users in question choose for themselves. This avatar is therefore chosen carefully, but its proprietor is constantly modifying it because their mood, their tastes and their needs change. An avatar must therefore represent their current mood, tastes and needs.

In a similar way, a personal robot can adopt a behavior configured by its proprietor, which can be a long and complex process.

One problem is that the user generally does not have the time to be constantly changing the parameters of their clone, although the attitude of the user is constantly evolving.

Moreover, a representation in the form of an avatar, even if approved, is not linked to the activity of the user in question or the emotions that characterize a human being as compared with a machine. There are nevertheless techniques for modifying the appearance of an avatar as a function of events external to the virtual world in which the avatar functions. However, such techniques do not take these events into account outside a so-called “connected” mode. For the avatar to be modified, and for these events to be taken into account, the user must be connected to the network, which is somewhat impractical because as soon as the user disconnects the avatar resumes a “static” appearance, i.e. the representation of the user no longer evolves.

The solution proposed by the invention is free of these drawbacks of the prior art. It provides a method of representing a user. The method according to the invention includes:
a step of determining at least one geographical location information item obtained from a terminal in the possession of said user; and
a step of configuring at least one means for representing said user taking account of said location information item.

Thus the invention allows dynamic configuration of the means for representing the user based on their geographical position, which allows at least the place in which the user is located to be taken into account when carrying out the configuration process. Thus considering a digital clone, which can be physically implemented by a set of data stored in a database or in the form of a file that is the virtual incarnation of a user, the location information is used as new variable data of the digital clone. This location data can then be used to configure means for representing the user, for example a robot in their home. Thus the invention configures an interface of the representation means in this way.

In one particular implementation of the invention, said method includes:
a step of obtaining at least one geographical location information item from a terminal of said user;
a step of obtaining at least one contextual information item linked to said at least one location information item;
a step of combining said at least one context information item and said at least one location information item to provide said at least one representation parameter; and
a step of dynamically setting the parameters of said representation means using said at least one representation parameter.

Thus, unlike prior art methods that impose manual parameter setting by the user of digital clones with which they interact or that represent them, the invention provides automatic configuration as a function of the position of a terminal of the user in space and time. Thus the user is not obliged to set the parameters of their digital clone manually.

It is equally possible in some implementations of the invention for the context information not to be present. In this situation, the method of the invention uses at least one position information item. Thus in some implementations information relating to the context of the user can be unavailable for one reason or another.

In the sense of the invention, a digital clone is defined as an incarnation of a user or a user group via a configurable machine. Such a representation can be a robot, for example, or a communicating object present in the home of the user that is a “double” of the user. This incarnation can equally take the form of a virtual representation of the user on a communications network such as the Internet. This incarnation can equally be the mobile terminal of the user, which can be configured automatically.

The invention achieves this result by obtaining information on the location of the terminal and, as a function of that location information, information linked to the context of the location information, for example the town in which the terminal is located, for example using a geographical information system. This information is then combined to obtain a representation parameter that is used by the digital clone.

Thus the method of the invention modifies the behavior of a communicating object such as a “Nabaztag” (Registered Trade Mark) robot, for example. This robot, which has connectivity functions and appearance modification functions, can for example be configured in real time by the method of the invention by:
obtaining the current location of the terminal of the user;
obtaining the current temperature at the location of the terminal;
combining these two items of information in the color blue, which is the representation parameter in this instance;
activating the blue diodes in the “Nabaztag” (Registered Trade Mark) robot.

The invention thus provides for configuring the digital clone without the drawbacks linked to the static configuration previously effected by users.

According to one particular feature of the invention, said method further includes:
a step of obtaining at least one personal information item relating to said user; and
said combination step also takes into account said at least one personal information item.

Thus the invention also takes account of sources of information other than those linked to the location of the user. This can be information as to the preferences of the user, for example, previously entered by the user. These preferences can take the form of a photo to be displayed, a movement to be effected or a state to be assumed, for example.

This personal information is ingeniously combined to supply representation parameters different from those linked only to location. The invention therefore creates different representations also as a function of who accesses the information (general public, more or less intimate circle of friends, etc.) and/or how the information is accessed (public, private).

In one particular implementation of the invention, said combination step includes:
a step of associating with said information at least one predefined parameter data item to provide at least one factual situation information item;
a step of interpreting said at least one factual situation information item;
a step of determining said at least one representation parameter from said at least one parameter data item.

Thus the invention configures a digital clone quickly, not by constructing the configuration parameters of the clone in their entirety, but by interpreting the information collected from the various sources and associating factual situation information with previously constituted parameter data, and configuring the clone is a fast and dynamic process. The invention therefore introduces the concept of the configuration of the clone evolving as a function of sources of data linked to the geographical position of the user's terminal and the evolution thereof.

According to one particular feature of the invention, said parameter setting step includes:
a step of formulation by an entity for implementing said digital clone of a request to an entity for managing said at least one representation parameter to obtain said at least one representation parameter;
a step of said management entity providing said at least one representation parameter; and
a step of said implementation entity configuring said digital clone.

Thus unlike some prior art techniques that push information toward the digital clone, the invention economizes on resources such as communications network resources by leaving it up to an entity implementing the digital clone to request new parameters. In some implementations of the invention, such an entity may be a module in the form of an electronic component integrated into the digital clone. This entity can equally take the form of equipment in the home to which the digital clone is connected. In other implementations of the invention, such an entity may be a service implemented within a service platform of a communications network such as the Internet. In one particular implementation of the invention, this entity may be a software component of a web server responsible for modifying the incarnation of the user on the network, even if the user is not directly connected to it.

The invention also provides a device for representing a user.

According to the invention, the device includes:
means for determining at least one geographical location information item obtained from a terminal in the possession of said user; and
means for configuring at least one means for representing said user taking account of said location information item.

Generally speaking, such a device includes means for implementing the configuration method as described above.

The invention also provides a system for representing a user.

According to the invention, the system includes:
means for determining at least one geographical location information item obtained from a terminal in the possession of said user; and
means for configuring at least one means for representing said user taking account of said location information item;
said configuration means being adapted to receive said location information item from said determination means via a communications network.

According to the invention, such a system includes means for taking account at least of information as to the geographical location of said user during execution of said configuration process.

Generally speaking, such a system includes means for implementing the configuration method described above.

Another aspect of the invention provides a computer program product downloadable from a communications network and/or stored on a computer-readable medium and/or executable by a microprocessor and including program code instructions for executing the configuration method described above.

Other features and advantages of the invention become more clearly apparent on reading the following description of one preferred example given by way of illustrative and non-limiting example only and from the appended drawings, in which:

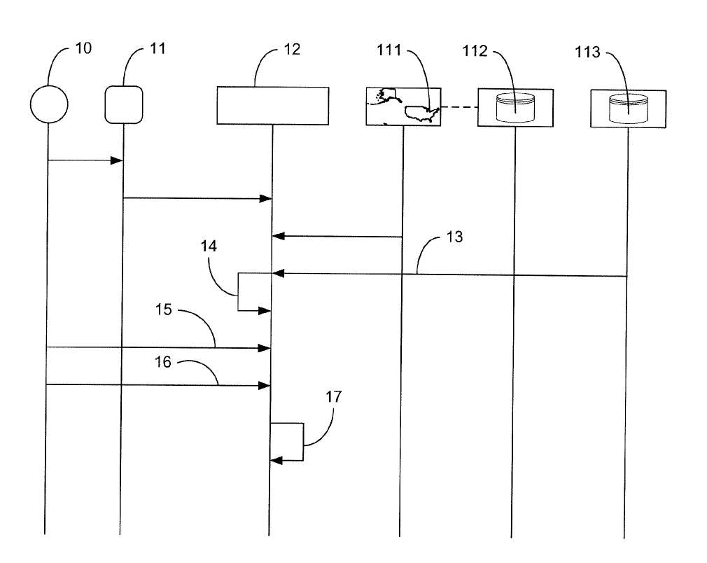

FIG. 1 is a block diagram showing the main steps of the method of the invention;

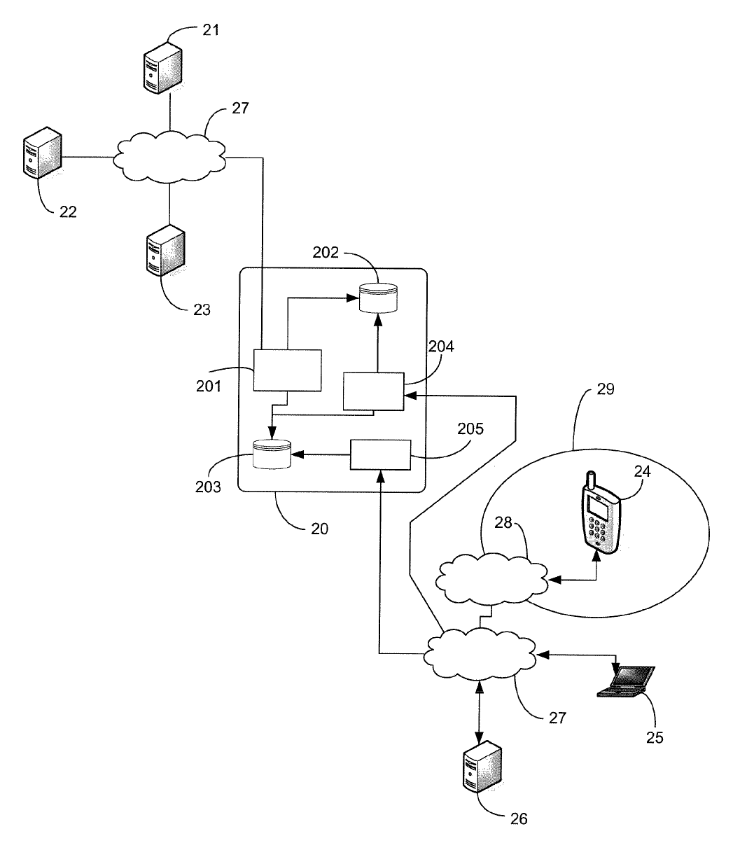

FIG. 2 shows an architecture for implementing the method of one implementation of the invention;

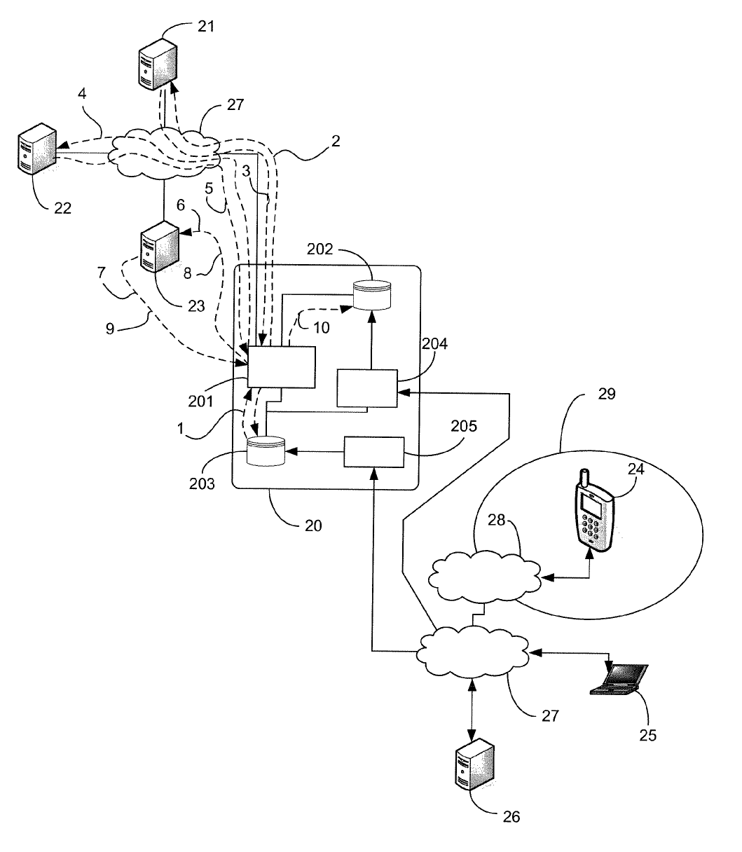

FIG. 3 shows a string of steps leading to the creation of two visual representations of a digital clone; and

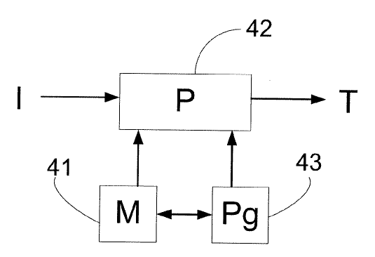

FIG. 4 shows succinctly a hardware architecture of a digital clone management entity of the invention.

### OUTLINE OF THE PRINCIPLE OF THE INVENTION

The invention dynamically configures a digital clone of a user that is interfaced with the “real world” via a representation mechanism. This representation can be a robot (a physical machine having connection functions), an avatar (a static or animated visual representation of the user on a communications network) or an audio system through which the digital clone can express itself. A digital clone includes data abstracted from parameterizable characteristics representative of a user. This data takes the form of a configuration file, for example. The parameters of this configuration file can be transposed visually through an avatar or robot-type representation, for example.

In other words, the invention represents a user by means of one or more configurable devices of a user or a group of users. For example, this configuration can be effected on a robot (or communicating object) in the home of the user that can be programmed as a “double” of the user. This configuration can equally take the form of a virtual representation of the user on a communications network such as the Internet. This configuration can also be implemented in the mobile terminal of the user.

According to the invention, the digital clone evolves over time without intervention by the user but with future states of the representations being known in advance. In other words, the user selects the sources of information that will be used to configure the behavior of their digital clone that will be used over time (the user knows that when they are riding their bicycle their digital clone will recover the configuration “when I am riding my bicycle: add to my avatar a car visible by my friends” so that the user knows in advance that their avatar will display a car visible only to their friends when they are riding their bicycle). The solution proposed by the invention is to have the clone evolve as a function of the behavior of a user with which it is associated and of the environment in which the user is functioning, in real time, so as to personalize dynamically the representation (or the presentation interface) of the digital clone (avatar, robot, communicating object, etc.).

There are numerous sources of information that can be ingeniously made use of:
geolocation by the GPS (Global Positioning System) or a mobile telephone;
background music, for example using a “Nabaztag” (Registered Trade Mark) robot;
the location of the user in their house, for example detected by a personal robot or an alarm system;
the location of the user in a predetermined place (store, park, museum, holiday resort, etc.).

All these non-declarative information sources represent a mine of information that could be considered intrusive unless its interpretation is advantageous to the user and sufficiently conceals the information source.

For example, with the geolocation of the owner obtained via their mobile telephone, it is possible to obtain the town in which they are located, to calculate their movement, the distance they cover during the day, their route, the weather where they are located or where they are going, etc. Each interpretation can impact on an aspect or behavior of the clone of the user via its representation interfaces (an on-line avatar or a robot in the house). For example, the weather automatically modifies the clothing of the avatar and tells the robot that it is cold. Moreover, the information sources for a group of persons can be combined to obtain a new clone that represents not one user in particular but a group of users.

In the context of the invention, it is important to distinguish clearly between:
the digital clone of the user, which can be configured dynamically via an entity dedicated to this purpose in a communications network; and
the representation of that clone, which can equally be managed by a communications network entity: this representation can be an avatar, a robot or a sound or other system.

The invention makes a clear distinction between these two levels of abstraction. Thus the invention does not relate to the manner in which an avatar is represented, but rather to a method of configuring a representation of the avatar in real time on the basis of a digital clone.

The general principle of the invention is described with reference to FIG. 1.

A user 10 has a terminal 11 from which the geographical position 111 of the user can be obtained.

This geographical position 111 is used by the digital clone management entity 12 to collect 13 and to interpret 14 other data 112, which can be linked to the geographical position 111. Other data 113 with no links to the geographical position 111 can also be collected 13 and interpreted 14, for example a user account identifier linked to the terminal, via a telephone number.

The user 10 has previously authorized collection of this data 111, 112, and 113. The user can also create 15 specific interpretations modifying the representation parameters of their digital clone. They can also choose 16 interpretations in a predefined list. The digital clone management entity 12 uses the collected data 111, 112, 113 and any user interpretations to configure 17 the digital clones of the user as a function of the representation interface.

There is described in particular below a use of the method of the invention for configuring a digital clone the representation interface of which is an avatar. It is nevertheless clear that the invention is not limited to this particular application, and can equally be used in numerous other fields and more generally in all situations where the advantages of the invention are of benefit.

### Description of One Implementation

In this implementation of the invention the method of the invention is used to interface the digital clone with an avatar. In this implementation, an interface of the digital clone management entity is implemented by means of a service available on a communications network such as the Internet. This interface of the digital clone management entity enables a user to set the parameters of the basic functions of the digital clone and also to set parameters of its representation interface.

In this implementation of the invention, when a user subscribes to the service provided by the management entity, he defines among other things his basic avatar.

The basic avatar is a character created from a library of components accessible on line (head, body, clothing, accessories, etc.). The user can also upload their own photograph, crop it with a dedicated on-line tool, and use it to create their character with their own head.

The user can choose a static background from a gallery of backgrounds on offer, upload a background himself or opt for the management entity to create a background dynamically as a function of their geolocation.

This implementation of the invention provides for enriching this basic avatar defined by the user with dynamic context information depending on the activity of the user. The method of the invention mixes these elements around the basic character.

The context information is created from the geolocation of the mobile telephone of the user. Because the user has been located at a given place, it is possible to set parameters of a digital clone using data including the name of the town in which the user is located, the weather at the place where they are located, an indication of movement (car, train, boat, etc.) as a function of the speed at which they are moving.

A photo, map, aerial or satellite view of the geolocation can also be a parameter for representing the clone. Of the context information not linked to the geolocation, the following elements can be added at the request of the user: star sign, current mood, short sentence characteristic of an activity or a place.

Other types of information can equally be provided: horoscope, daily joke, etc.

There are further possibilities: having located the person at a given place, the invention can indicate to the user other means for joining that person at that time (mobile telephone, landline telephone, instant messaging, etc.). Thus the invention can supply via the representation interface not only representation information but also complementary ways to contact the user or members of their family, for example.

The star sign is deduced from the user's date of birth. The other elements: basic avatar, mood, phrase, joke, contact means, etc. can be modified at any time by the user or by the management entity, for example as a function of the location.

In this implementation of the invention, the management entity creates systematically (i.e. dynamically) for a given user at a given geolocation two representation interfaces representing them:
a 150×225 pixels first representation is created to be viewable on websites in general;
a 100×100 pixels second representation is created to be easily viewable in instant messaging applications and “Live Messenger” (Registered Trade Mark) applications, and on mobile terminals.

In other implementations, the management entity can create dynamically, as a function of confidentiality parameters selected by the user and as a function of the geolocation of the terminal, representations that will be used differently according to whether another user who enters into contact with the representation interface is known to the first user or not. Thus the invention provides for configuring digital clones differently according to whether a clone is “public” or “private”.

The various representations of the digital clone need not contain the same information. For example, where a domestic robot represents a family member, the management entity could supply to the interface configuration parameters that are different (more personal) than parameters used to configure a representation of the user on a social network.

At a time T, the representation of the same digital clone can be different according to who is accessing the information and how they are accessing it (access network, terminals in the broad sense).

An example of a hardware architecture that can be used for this implementation of the invention is described below with reference to FIG. 2.
The digital clone management entity (20) comprising the following subsystems:
   a database 203;
   a disk storage space 202;
   a service 201 in the form of an application;
   a website 204;
   a web service 205;
a third party geolocation server 21;
a third party weather server 22;
a third party photograph sharing server 23;
a user 24 of the service implemented by the management entity via mobile telephone;
a user 25 of the service implemented by the management entity via web application;
an Internet server 26 (blog, Netvibes gadget, Live.com, etc.) having a link (uniform resource locator (URL)) to the management entity 20;
a data exchange network 27 such as the Internet;
a cellular network 28 (for example a GPRS/EDGE/UMTS/HSDPA network) with a coverage area 29 and to which the mobile terminal 24 is connected.

The service provided by the management entity 20 is based on the use of a central server functionally divided into a plurality of parts:
a database 203 for storing user accounts and user parameters; the representations generated are also stored in this database;
a disk storage space 202: the web representation of a digital clone of a user is also stored in file form to enable direct access from certain personal publication spaces (“blogs”) or servers (direct access using a URL); in this implementation of the invention, this “centralized” storage enables the management entity to hold the dynamic representations of the users at a single location and to supply them to the various services that may require them;
a service 201 that represents the core of the management entity:
   this service periodically reads the database of users and recovers their parameters;
   it then submits requests to third-party (public or private) servers for, among other things, geolocating the user, recovering the weather at their geolocation, recovering a photo, map or street plan of their geolocation;
   when all elements have been recovered, and depending on what the user wants, a Web type or Live Messenger/Mobile type representation is generated and saved in the database and on disk;
a web site 204 for receiving HTTP requests from users either in the form of a request for a file URL (www.mywebsite.com/christian.png) or in the form a request for a representation on the basis of a pseudonym (www.mywebsite.com/awazzar?pseudo=christian);
a web service 205 for more complex requests also enabling users to modify their configuration parameters and their basic representation (e.g. their character).

The digital clone management entity 20 accesses third-party servers 21, 22, 23 to recover user geolocation information (street, town, zip code, longitude, latitude), for example using the HTTP protocol. Using this information, the digital clone management entity 20 can make requests to other servers, for example to find out the weather at that location (temperature, sun/cloud, etc.) and to recover a photograph of that location.

The users 24, 25, 26 access the digital clone management entity 20 via the Internet using a web server for simple requests or a web service for more complex requests with numerous parameters. The digital clone management entity 20 is then in a position to decide how to set the parameters of the representation of the digital clone as a function of requests sent by the users 24, 25, 26.

In this implementation, a personal robot of the user, for example in their home, can also access the digital clone management entity 20 via a URL and using connectivity functions.

### Preconfiguration

If a user wishes to subscribe to a service provided by the management entity of the invention, they connect to the website 205 of the server. They receive a welcome page containing a registration form. During this registration phase the following parameters are registered in a database:
an identifier uniquely identifying the user (for example an instant messaging application identifier);
a mobile telephone number that can be used to geolocate the user;
a pseudonym of the user (the server verifies that this pseudonym is unique at subscription time);
a password;
a date of birth (for deducing the star sign);
a matrimonial status.

Other elements can of course be provided, as a function of related data that is to be interpreted.

In this implementation of the invention, pages for creating an avatar can be accessed independently of whether a subscription to the service provided by the management entity has been taken out beforehand or not. The digital clone management service is available only to subscribers to the service.

In this implementation, a user creates their visual representation in the form of an avatar (character) by selecting from a gallery of heads, hairstyles, eyes, mouths, upper body garments, lower body garments, and accessories. The user can also upload their own photo, crop it using a dedicated on-line tool, and use it to create a character with their own head. These preconfiguration steps enable the management entity to modify the parameters of the digital clone afterwards. The creation interface enables the user to view their choices in real time and to view the graphical rendition by prior visualization on a web page and/or via an instant messaging application and/or as a function of a private or public profile. This basic representation is saved in the database in relation to the parameters of the user.

The user can equally choose between having a background image added automatically as a function of their geolocation, choosing a fixed background image from a preloaded image gallery or uploading their own background image.

A dedicated configuration screen enables the user to select how they wish to be visible as a function of the medium: web, instant messaging, mobile telephone, other means for viewing and/or accessing information. On this screen, the user can define for each medium the information that they wish to present (information that is linked to the geolocation or additional contextual information). The user can select the following options, for example:
web visualization:
   display of a personal message;
   display of the temperature and weather;
   display of mood;
   display of star sign;
   display of their geolocation;
instant messaging and mobile phone visualization:
   no display of personal message;
   display of temperature and weather;
   display of mood;
   display of their geolocation with greater precision because the information will be accessible to a private circle.

The right-hand part of the screen shows the user their representation in both these visualization modes in real time.

### Configuration

The main steps of the configuration method of the invention are described below with reference to FIG. 3, based on the general architecture from FIG. 2, of which the following elements are used:
a digital clone management entity 20 further including a database containing parameters of users;
a geolocation server 21 using the mobile telephone number;
a weather forecasting server 22;
a photo-sharing server 23;
a person to be geolocated by means of their terminal 24, which has the telephone number 123;
a GSM radio coverage area 29 of a mobile network 28.

The digital clone management entity 20 periodically carries out for each user the operations described below (steps 1 to 10).

The period at which these operations are effected is a parameter and has a default value of 15 minutes in this implementation. This means that, for one user, the operations described below (steps 1 to 10) are carried out every 15 minutes. Other periods are possible, of course.

It is equally possible, in a different implementation, to effect steps 1 to 10 at the time of a user request. The representation of the person requested will then not be that dating back 15 minutes maximum but their instantaneous representation.

The steps of the method are described for geolocation of a user whose mobile phone number is 123.

### Step 1

The digital clone management entity 20 reads in the database parameters of the user 24: mobile telephone number 123, digital clone parameter criteria, etc.

### Step 2

The digital clone management entity 20 geolocates the user 24 by sending an HTTP request to a third-party geolocation server 21. This request depends on the API supplied by the third-part geolocation server 21. In this instance, the request is an HTTPS request with authentication by login/password for identifying the requesting server (the management entity 20) sent with the parameters in an XML stream.

This XML stream contains the identity of the requesting server (the management entity 20), the number of the phone to be geolocated (123), and the type of geolocation required (street, town, zip code, latitude, longitude).

With the geolocation server used here it is possible to have three types of geolocation:
geolocation with return of an indication of street, town, zip code, latitude and longitude;
geolocation with return of an indication of latitude and longitude; or
geolocation with return of a position on a map.

The digital clone management entity 20 requests a response of the first type.

In response, the geolocation server 21 sends an HTTP response containing parameters in the form of an XML stream with the following response elements: telephone number, geolocation date and time, street, town, zip code, latitude and longitude.

Step 3 follows if the geolocation server 21 responds to the request submitted in step 2.

If the geolocation server does not respond or sends an error code reporting that it is not possible to geolocate the person for technical reasons (geolocation server down, person not locatable because their telephone is switched off, etc.) the process is aborted. In this situation no representation is created and the user's old representations are retained.

If the user has deactivated geolocation (because they no longer wish to be located), the process is interrupted and step 10 is executed as a function of other information that is available.

### Step 3

The geolocation server 21 sends usable geolocation elements. The digital clone management entity 20 saves the elements received (street, town, zip code, latitude and longitude).

For example, information such as “rue Leclerc, Issy les Moulineaux, 92130, X and Y” is saved. The digital clone management entity 20 also determines a speed of movement relative to the preceding geolocation. If this speed of movement is high a fast mobility indicator is set, subsequently enabling an indicator to be added characterizing the movement of the person (step 10).

Step 4 follows when geolocation is completed.

### Step 4

The person 24 has now been geolocated successfully and the digital clone management entity 20 extracts the department code (here 92) from the zip code (here 92130) recovered by geolocation.

The digital clone management entity 20 then determines from an internal table if it knows the weather in this department in a previous period not exceeding X hours (X is a parameter set by default at 12 hours). This prevents overloading other services, in particular the weather information service.

If the weather in the department is known in a previous period not exceeding

X hours then no new request is made for weather conditions, and step 6 follows directly. If the weather for the department is not known or if the known weather is more than X hours old then the following operations are undertaken (step 4).

The digital clone management entity 20 sends an HTTP request to the weather data server 22 to obtain the current weather for the department concerned. This request depends on the API supplied by the third party weather server 22.

In this implementation, the department number is matched to a coded string specific to the weather server used via a look-up table. Here, for department 92, the following code must be sent to the server 22: “FRXX0202?letter=N”.

The request sent to the weather server 22 is an HTTP request with this coded string as a parameter. The coded string contains a specific code of a weather station of a town in the department (sometimes, although not necessarily, the prefecture) followed by an indication that what is required is the current weather and not forecasts for the next few days.

The server sends back an HTTP response containing parameters in the form of an XML string containing varied information, although the digital clone management entity 20 uses only the following elements: current temperature, number of icon representing current weather.

This implementation of the invention uses an Internet public weather server 22. Requests can be submitted to this server regularly via a web service after registration with the server and subject to payment. Such servers nevertheless offer anonymous access in the form of simple HTTP requests provided that such requests are not submitted more frequently than every 12 hours, hence the mechanism employed in this implementation.

If the weather server 22 responds to the step 4 request, then step 5 follows. If the weather server sends back an error code or does not respond, then the process is aborted. Under such circumstances no new representation is created and the user's old representations are retained.

### Step 5

The weather server 22 has now sent usable weather elements and the digital clone management entity 20 saves the elements received (current temperature and number of icon representing current weather).

For example, the information saved is “6°” and “icon 12”.
If during the configuration process carried out beforehand the user selected dynamic creation of a representation background, then step 6 follows.
If during the configuration process carried out beforehand the user selected static creation of a representation background by providing a background image, then creation of the representation (step 10) follows directly.

### Step 6

The digital clone management entity 20 requests a list of photographs of the town (Issy les Moulineaux) in which the person 24 has been located from a photo-sharing Internet server 23.

As function of the type of background selected by the user, a request can also be submitted to a map server (street plan, aerial or satellite map).

This request depends on the API provided by the third-party photo-sharing server 23.

In this implementation, sending the request to the photo server entails sending an HTTP request with parameters including a character string corresponding to the name of the town (?tags=Issy les Moulineaux&format=rss_{—}200).

The server returns an HTTP response with parameters including an RSS 2.0 feed containing a list of all the photos stored having a tag with the name of the requested town. If the photo server 23 responds to the request of the step 6, then step 7 follows.

If the photo server returns an error code or does not respond, then the process is aborted. Under such circumstances no new representation is created and the user's old representations are retained.

### Step 7

The photo server 23 has now returned usable elements and the digital clone management entity 20 analyzes the RSS stream received:
if the photo server 23 has no photo corresponding to the requested town then step 10 follows using a default image as the screen background;
if the photo server 23 has only one photo corresponding to the requested town then step 8 follows to recover that photo;
if the photo server has a plurality of photos corresponding to the requested town then the digital clone management entity 20 draws the reference of one of the received photos at random and step 8 follows to recover that photo.

### Step 8

The digital clone management entity 20 sends a request to the photo server 23 to recover a specific photograph.

In this implementation of the invention, the request sent to the photo server entails sending an HTTP request with the complete url of the photo to be recovered (url server/issylesmoulineaux4.png).

In return the photo server sends the bit map of the requested photo.

If the photo server 23 responds to this request, then step 9 follows.

If the photo server returns an error code or does not respond, then the process is aborted. Under such circumstances no new representation is created and the user's old representations are retained.

### Step 9

The photo server 23 has returned the requested photograph to the digital clone management entity 20, which saves the bit map of the photo and stores it in memory before proceeding to step 10.

### Step 10

All elements are combined to create digital representations of the user 24 as configured by the user.

The digital clone management entity 20 executes the steps 10a and 10b successively.

### Step 10a: Creating a Representation of the Viewable Digital Clone Via a Web Site

This operation entails creating a 150×225 pixel representation viewable by means of the web:
if the user has chosen a static background, the background image selected by the user is loaded into memory;
if the user has chosen a dynamic background, the photograph previously recovered is loaded into memory; by default, if it has not been possible to recover a photo (there are no photos on the server), then a default photo is loaded into memory.

The background image is resized, if necessary, to the 150×225 pixel size. The following elements are then successively overlaid on this background image, each at a specific location determined by a parameter:
the avatar (character) defined by the user;
if the digital clone management entity 20 has determined that the user is moving fast, a car or boat image is added as a function of the location of the person;
a personal message if the user has chosen to display a personal message;
the temperature and the icon corresponding to the weather at their location if the user has chosen to display the weather; in this example, the values 6° and icon 12 (rain) are added;
the icon (which the user has predefined) corresponding to their mood if the user has chosen to display their mood;
the icon corresponding to their star sign (deduced from their date of birth) if the user has chosen to display their star sign;
the name of the town in which they have just been geolocated if the user has chosen to display their geolocation; in this example, “Issy les Moulineaux”.

Other elements are possible:
if the user has chosen to display their joke of the day, then the joke that they have chosen beforehand is displayed;
if the user has chosen to display their matrimonial status, then an icon representing that status is displayed;
other displays as a function of their choices and graphics possibilities.

Accordingly, in this implementation of the invention, a dynamic representation of the user has been created on the basis of their geolocation. It is important to note that, according to the invention, all the parameter values are selected without intervention by the user (apart from selecting the parameters beforehand). In other words, the invention does not oblige the user to enter into communication to select the parameters of their digital clone and to communicate those parameters. Thus even if the user is “off line”, i.e. is not connected to communications means, the invention causes the representation of their digital clone to evolve as a function of their movements.

In this implementation of the invention, the digital clone management entity saves a file on disk. Such a file may be necessary so that it can be accessed from websites using only a URL. This is not obligatory, however. Rather than referring to the representation by means of a file, it is possible (and envisaged) to refer to it by means of a URL containing representation interrogation parameters, for example enabling dynamic creation of the representation as a function of the user seeking to access it. Access to this representation by users can also be effected by a request to a web service that, depending on the request submitted, delivers the above representation as generated but comprising also additional context information according to the parameters selected.

### Step 10b: Creating a Viewable Representation Using Instant Messaging

This operation entails creating a 100×100 pixel representation viewable on instant messaging services and mobile telephones.

In this implementation, the dynamic background is not included in the parameters taken into account for this type of representation, as the representation is too small. Similarly, there are fewer viewable elements because of the reduced space. If the user has chosen a static background, the background image selected by the user is loaded into memory; otherwise a neutral background is used. On this background image are successively superimposed the following elements, each at a specific and parameterizable location:
the avatar (character) defined by the user;
if the digital clone management entity 20 has determined that the user is moving fast between two geolocations, a car or boat image is added as a function of the location of the person;
the temperature and the icon corresponding to the weather at their location if the user has chosen to display the weather; in this example, the values 6° and icon 12 (rain) are added;
the icon (which the user has predefined) that corresponds to their mood if the user has chosen to display their mood;
the name of the town in which they have just been geolocated if the user has chosen to display their geolocation; in this example, “Issy les Moulineaux” is added.

Once created, this specific representation is saved in a database.

In this implementation of the invention, intended to provide a representation accessible via instant messaging and/or mobile telephone, access by users to this representation is effected by means of a request to a web service that delivers, according to the request submitted, the above representation as generated but further comprising the following context information:
if the user has chosen to display a personal message, their personal message;
if the user has chosen to display their joke of the day, then the joke that they have chosen beforehand is displayed;
if the user has chosen to display their matrimonial status, their matrimonial status is displayed.

This implementation of the invention has been described as applied to creating a representation of a digital clone in the form of an image. The invention is in no way limited to this visual aspect, and applies equally to the configuration of domestic robots that can, like a web service, obtain operating parameters from the digital clone management entity as a function of the geolocation of the user or the group of users that they represent.

For example, in the context of a representation interface such as a robot that has surveillance capabilities (for example an “Aïbo” (Registered Trade Mark) robot), the method of the invention can easily activate or deactivate the surveillance system of the robot as a function of the movements of the persons that constitute the household. In other words, the invention provides this robot with the parameters necessary to activate it when all the members of the family are away from home. Conversely, the method of the invention deactivates this function of the robot if at least one member of the family is about to enter the home.

This simple translation of the intention of the “family” digital clone representing all family members illustrates the possibilities offered by the method of the invention.

### Other Optional Features and Advantages

FIG. 4 shows a digital clone management entity of the invention.

It includes a buffer memory 41 and a processor unit 42 equipped with a microprocessor μP, for example, and controlled by a computer program 43 implementing the processing method of the invention.

On initialization, the code instructions of the computer program 43 are loaded into RAM before being executed by the processor of processor unit 42, for example. The processor unit 42 receives as input at least one item I of information to be transmitted (such as a response to a request to interrogate a context information provider server). The microprocessor of the processor unit 42 executes the steps of the method described above in accordance with the instructions of the computer program 43 to deliver a processed information item T (such as a configuration parameter of the digital clone). To this end, the sending entity includes, in addition to the buffer memory 41, information (in particular geolocation and context information) processing means for executing the method of the invention. Those means are controlled by the microprocessor of the processor unit 42.

1. A method of representing a user, comprising:
determining at least one geographical location information item obtained from a terminal in the possession of said user; and
configuring at least one means for representing said user taking account of said at least one location information item.

2. A method according to claim 1, wherein said configuration step includes:
obtaining said at least one geographical location information item from said terminal of said user;
obtaining at least one contextual information item linked to said at least one location information item;
combining said at least one context information item and said at least one location information item to provide said at least one representation parameter; and
dynamically setting the parameters of said representation means using said at least one representation parameter.

3. A configuration method according to claim 2, wherein said configuration phase further includes:
obtaining at least one personal information item relating to said user; and
in that said combination step also takes said at least one personal information item into account.

4. A configuration method according to claim 2, wherein said combination step includes:
associating with said information at least one predefined parameter data item to provide at least one factual situation information item;
interpreting said at least one factual situation information item; and
determining said at least one representation parameter from said at least one parameter data item.

5. A configuration method according to claim 2, wherein said parameter obtaining step includes:
formulation by an entity for implementing said representation means of a request to an entity for managing said at least one representation parameter to obtain said at least one representation parameter;
said management entity providing said at least one representation parameter; and
said implementation entity configuring said representation means.

6. A device for representing a user comprising:
means for determining at least one geographical location information item obtained from a terminal in the possession of said user; and
means for configuring at least one means for representing said user taking account of said location information item.

7. A system for representing a user comprising:
means for determining at least one geographical location information item obtained from a terminal in the possession of said user; and
means for configuring at least one means for representing said user taking account of said location information item;
said configuration means being adapted to receive said location information item from said determination means via a communications network.

8. A computer program product that is at lest one of: a) downloadable from a communications network and b) stored on a computer-readable medium and executable by a microprocessor, wherein it includes program code instructions for executing the representation method according to claim 1 when it is executed on a computer.
